(19) United States
(12) Patent Application Publication
(10) Pub. No.: US 2026/0062063 A1
(43) Pub. Date: Mar. 5, 2026

(54) VEHICLE STRUCTURE

(71) Applicant: HONDA MOTOR CO., LTD., Tokyo (JP)

(72) Inventor: Naoki TANI, Tokyo (JP)

(21) Appl. No.: 19/303,499

(22) Filed: Aug. 19, 2025

(30) Foreign Application Priority Data
Aug. 29, 2024 (JP) 2024-147874

(51) Int. Cl. B62D 25/16

(52) U.S. Cl. CPC B62D 25/16

(57) ABSTRACT

A vehicle structure includes a structural body, in which a pair of wheel houses and a floor panel are integrally formed by die casting. The floor panel includes a frame connection portion, to which an inboard end portion of the frame is connected. Each wheel house includes: a concave surface portion that faces outward in a vehicle width direction; and a convex surface portion that is formed on a back side of the concave surface portion. The concave surface portion faces outward in the vehicle width direction, and a part of a wheel is housed therein. The concave surface portion has an inclined rib that is disposed above the frame connection portion, that extends from a lower portion of an outboard side toward an upper portion of an inboard side in the front-rear direction of the vehicle, and that rises toward an outer side in the vehicle width direction.

### CROSS-REFERENCE TO RELATED APPLICATION

This application claims the benefit of foreign priority to Japanese Patent Application No. 2024-147874, filed on Aug. 29, 2024, which is incorporated by reference in its entirety.

### TECHNICAL FIELD

The present invention relates to a vehicle structure in which wheel houses are formed by casting.

### BACKGROUND

In recent years, research and development efforts have been focused on weight reduction to improve energy efficiency. The goal is to make affordable, reliable, sustainable, and advanced energy accessible to more people.

For example, a vehicle needs to have strength to protect an occupant at the time of collision, and is required to be reduced in weight to improve fuel efficiency and electric efficiency.

Under such a background, Chinese Patent Application Publication No. 117360634 proposes a technique of integrally forming a pair of left and right wheel houses in a rear portion of a vehicle, a cross beam connecting the wheel houses, and a longitudinal beam extending in a front-rear direction by die casting.

In addition, when the vehicle is collided from the rear side, the collision load is transmitted to the longitudinal and lateral beams.

However, in the configuration disclosed in CN 117360634 A, since the transmission path of the load is the same as that of the conventional vehicle structure, there is room for improvement in terms of weight reduction.

### SUMMARY

The present invention has been made to solve the above problem, and an object of the present invention is to provide a vehicle structure capable of reducing the weight of a vehicle while increasing the strength against a collision load. This also contributes to improvement of energy efficiency.

To solve the above problem, a vehicle structure according to the present invention includes a structural body, in which a pair of wheel houses disposed apart from each other in a right-left direction, and a floor panel connecting the pair of wheel houses are integrally formed by die casting. In the vehicle structure, the floor panel includes a frame connection portion, to which an inboard end portion of a frame extending along a front-rear direction of a vehicle is connected. Each of the wheel houses is shaped like a shell and includes: a concave surface portion that faces outward in a vehicle width direction and is formed of a concave curved surface curved in a substantially spherical shape, and a convex surface portion that is formed on a back side of the concave surface portion, protrudes inward in the vehicle width direction, and is formed of a convex curved surface curved in a substantially spherical shape. The concave surface portion is disposed so as to face outward in the vehicle width direction, and a part of a wheel is housed in the concave surface portion. The concave surface portion has an inclined rib that is disposed above the frame connection portion, that extends from a lower portion of an outboard side toward an upper portion of an inboard side in the front-rear direction of the vehicle, and that rises toward an outer side in the vehicle width direction.

### BRIEF DESCRIPTION OF THE DRAWINGS

The drawings described herein are for illustration purposes only and are not intended to limit the scope of the present invention in any way.

FIG. 1 is a perspective view of a structural body that constitutes a vehicle structure according to one embodiment.

FIG. 2 is a plan view of the structural body.

FIG. 3 is a cross-sectional view taken along the line III-III in FIG. 2.

FIG. 4 is a side view of the structural body that constitutes the vehicle structure of this embodiment, as seen from the left side of the vehicle.

FIG. 5 is a side view, as seen from the left side, showing a state in which a vehicle power source and a suspension have been assembled to the structural body that constitutes the vehicle structure of this embodiment.

FIG. 6 is a perspective view of the structural body that constitutes the vehicle structure of this embodiment, as seen from the lower left side of the vehicle.

FIG. 7 is a perspective view of a left rear wheel house of the structural body that constitutes the vehicle structure of this embodiment, as seen from above at the right side of the vehicle.

FIG. 8 is a side view, as seen from the left side of the vehicle, showing a state of the vehicle to which the structural body that constitutes the vehicle structure of this embodiment has been assembled.

FIG. 9 is a side view of the vehicle, as viewed from the inner side of the vehicle, showing a state of the vehicle to which the structural body that constitutes the vehicle structure of this embodiment has been assembled.

### DETAILED DESCRIPTION

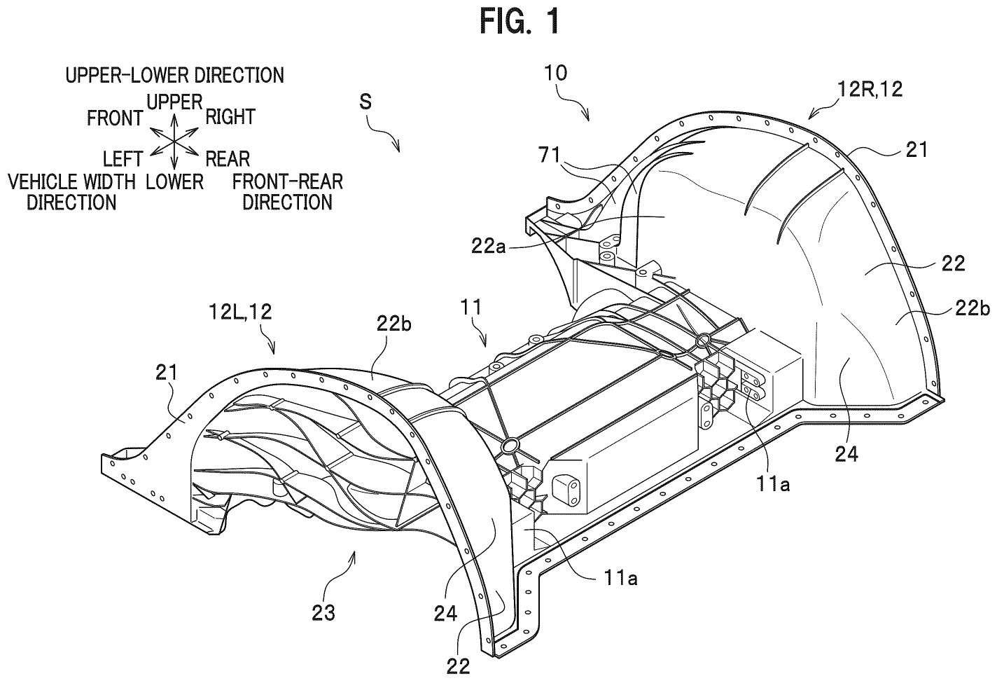

A vehicle structure S of a vehicle according to one embodiment of the present invention will be described in detail with reference to FIGS. 1 to 9.

In the description, the same elements are denoted by the same reference numerals, and duplicated description will be omitted.

The vehicle structure S according to this embodiment includes a structural body 10, which constitutes a rear side of a vehicle-body V1 (see FIGS. 1, 2, 8, and 9).

Therefore, in the following description, an inboard side in a front-rear direction of the vehicle indicates a front side of the vehicle, and an outboard side in the front-rear direction of the vehicle indicates a rear side of the vehicle.

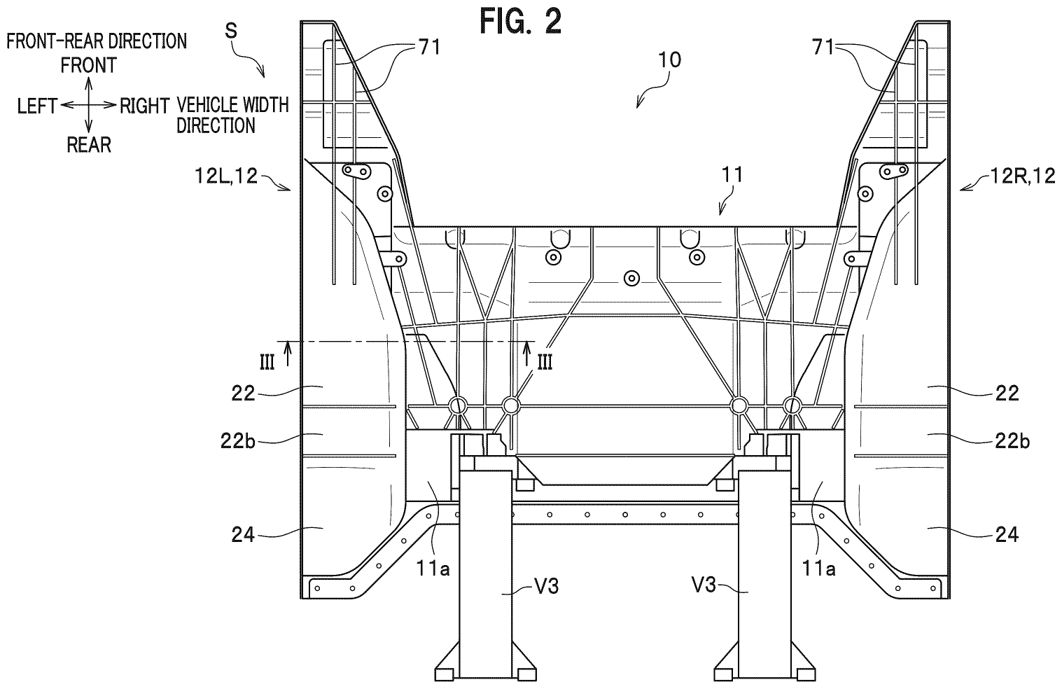

The structural body 10 is produced by die-casting an aluminum alloy (see FIGS. 1 and 2).

The structural body 10 includes a floor panel 11 (floor panel), a right rear wheel house 12R (wheel house 12), and a left rear wheel house 12L (wheel house 12).

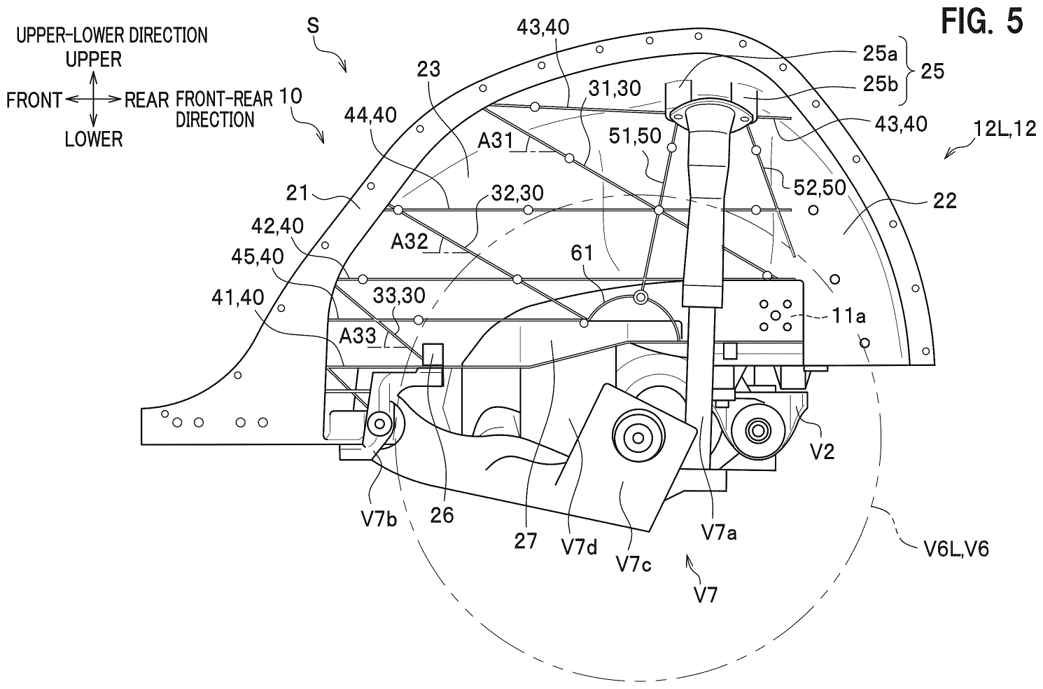

The right rear wheel house 12R is disposed on the right side of the rear of the vehicle body, and a right rear wheel (wheel V6) is rotatably housed therein (see FIG. 5).

The left rear wheel house 12L is disposed on the left side of the rear of the vehicle body, and a left rear wheel V6L (wheel V6) is rotatably housed therein.

The right rear wheel house 12R and the left rear wheel house 12L are disposed at a predetermined interval in a vehicle width direction of the vehicle. The right rear wheel house 12R and the left rear wheel house 12L are integrally connected by the floor panel 11.

In other words, the structural body 10 is integrally formed by die-casting the pair of wheel houses 12R, 12L together with the floor panel 11 that connects the wheel houses 12R, 12L.

The right rear wheel house 12R and the left rear wheel house 12L are formed in planar symmetry with respect to a center plane in the vehicle width direction as a plane of symmetry.

In the following detailed description, only the left rear wheel house 12L will be described, and the description of the right rear wheel house 12R will be omitted.

A vehicular power source V2 such as a motor and a reduction gear is mounted on the floor panel 11 (see FIG. 5).

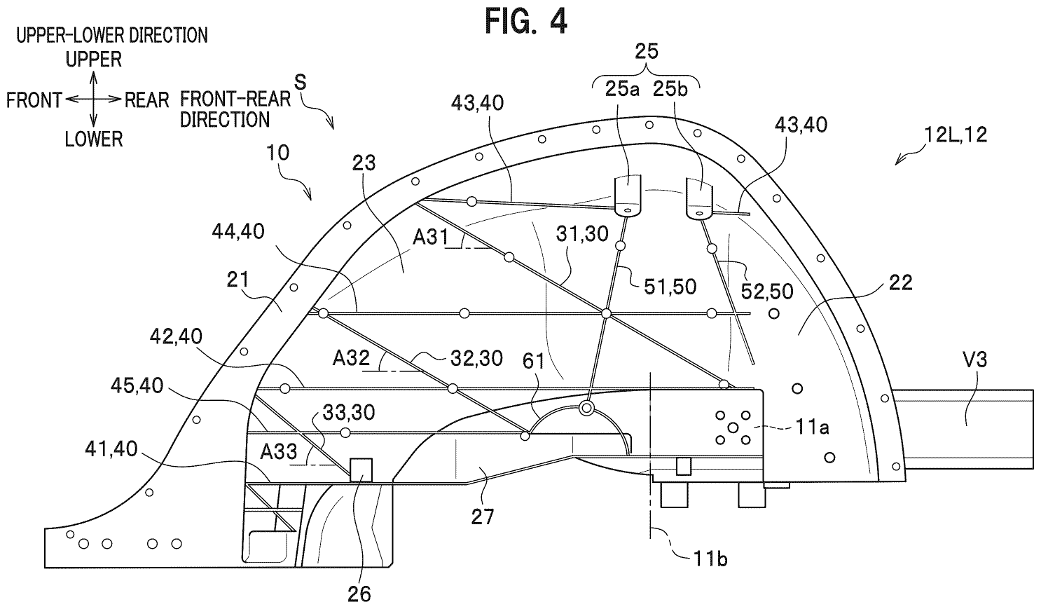

A front end portion (an inboard end portion in the front-rear direction of the vehicle) of a rear frame V3 (frame) is connected to the floor panel 11 (see FIGS. 2 and 4).

The rear frame V3 is a member that transmits a collision load to the front side of the vehicle body when a collision occurs from the rear side of the vehicle.

A rear bumper (not shown) is provided at the rear end of the rear frame V3.

The left rear wheel house 12L (wheel house 12) includes a vehicle body connecting portion 21 and a house body 22.

The vehicle body connecting portion 21 is a component for fixing the right and left wheel houses 12R, 12L to a vehicle body panel V4 constituting the vehicle body V1.

The vehicle body connecting portion 21 is formed in a flange shape at position of the house body 22 that comes into contact with an inside panel V4a of the vehicle body V1.

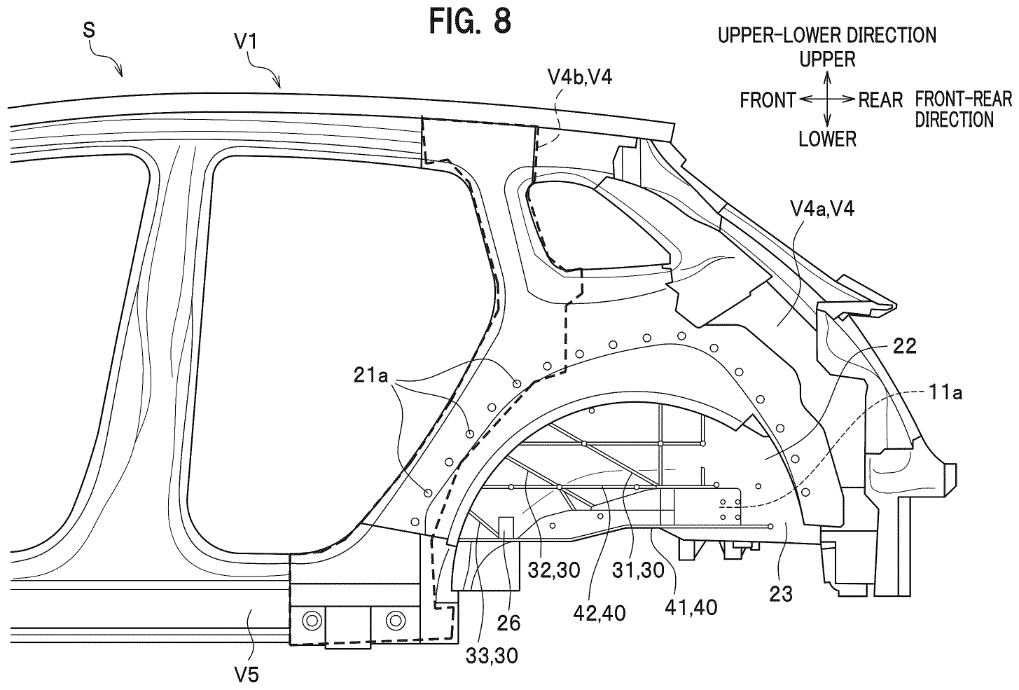

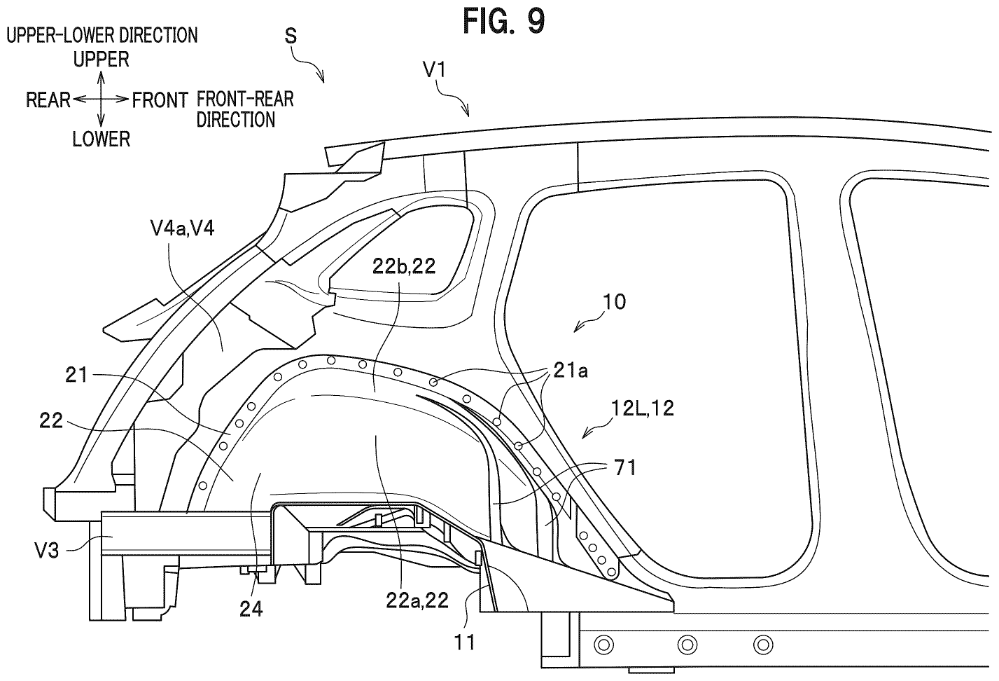

The vehicle body connecting portion 21 is joined to the inside panel V4a by a method such as spot-welding using a plurality of joining points 21a and thus installed (see FIGS. 8 and 9).

A quarter pillar stiffener V4b is provided on an outboard side surface of the inside panel V4a.

The quarter pillar stiffener V4b is a structural member for increasing the strength of a rear edge portion of a rear seat entrance.

Further, a side sill V5 is provided as a structural member for increasing the strength of a lower edge portion of the rear seat entrance.

The house body 22 has a substantially quarter-spherical shell shape that is formed by a side portion 22a and a vehicle width portion 22b (see FIGS. 1 to 7).

The side portion 22a is formed in a substantially semicircular plate shape and is disposed to face the vehicle width direction.

The vehicle width portion 22b is formed of a belt-like member that protrudes outward in the vehicle width direction from an circular arc edge portion of the side portion 22a and is curved along the circular arc portion of the side portion 22a.

The angle A22b of the vehicle width portion 22b, defined between the tangent line to a surface near a top portion in an upper-lower direction of the vehicle and the horizontal plane, is set to be 45 degrees or lower.

It is noted that the angle A22b of 45 degrees or lower may also be defined between the tangent line to a surface other than that near the top portion and the horizontal plane, in the vehicle width direction.

A concave curved surface that is curved into a substantially spherical shape and formed by an outer surface of the side portion 22a in the vehicle width direction and an outer surface of the vehicle width portion 22b in the vehicle width direction is refereed to as a concave surface portion 23.

Further, a convex curved surface that is curved into a substantially spherical shape and formed by an inner surface of the side portion 22a in the vehicle width direction and an inner surface of the vehicle width portion 22b in the vehicle width direction is refereed to as a convex surface portion 24.

In other words, a surface of the house body 22 that is recessed outward in the vehicle width direction is referred to as the concave surface portion 23, and a surface of the house body 22 that protrudes inward in the vehicle width direction is referred to as the convex surface portion 24.

The house body 22 is formed in a substantially quarter spherical shell shape by the concave surface portion 23 and the convex surface portion 24.

The house body 22 is disposed on the vehicle-body V1 in a state where the concave surface portion 23 faces outward in the vehicle width direction, the convex surface portion 24 faces inward in the vehicle-width direction, and an opening portion opens outward in the vehicle width direction and downward of the vehicle.

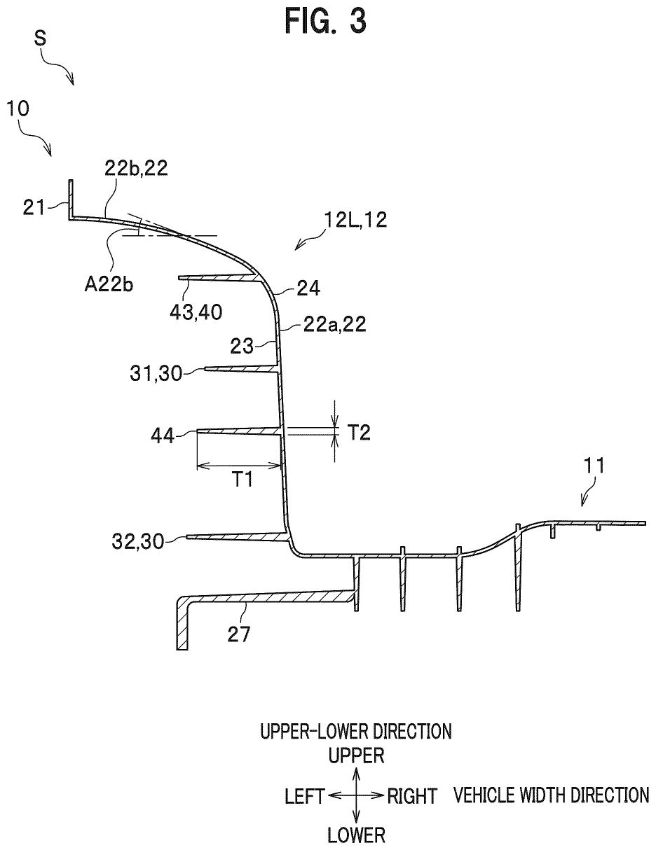

The concave surface portion 23 is provided with a damper fixing portion 25, an arm support portion 26, a spring holding portion 27, a first inclined rib 31, a second inclined rib 32, a third inclined rib 33, a first horizontal rib 41, a second horizontal rib 42, a third horizontal rib 43, a fourth horizontal rib 44, a fifth horizontal rib 45, a first damper fixing portion reinforcing rib 51, a second damper fixing portion reinforcing rib 52, and a branch rib 61 (see FIGS. 3 to 6).

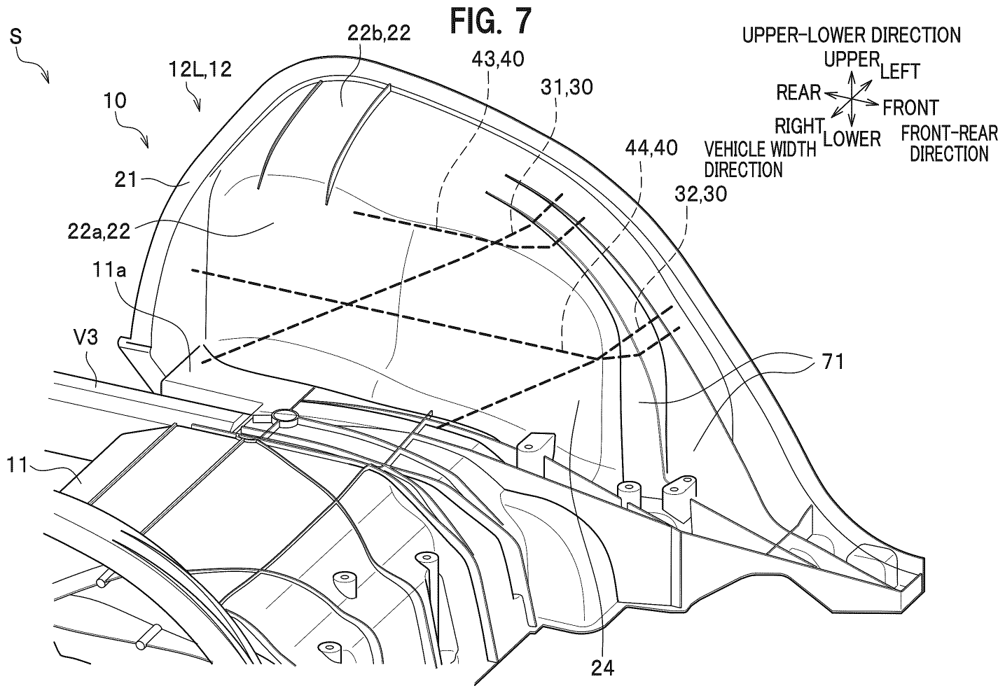

Further, the convex surface portion 24 is provided with a pair of reinforcing ribs 71 (see FIG. 7).

The damper fixing portion 25 is a pedestal that serves to support an upper end portion of a damper V7a for suspending the left rear wheel V6L (wheel V6) (see FIGS. 4 to 6).

The damper fixing portion 25 is disposed on the uppermost side of a portion where the side portion 22a of the concave surface portion 23 and the vehicle width portion 22b are connected to each other.

The damper fixing portion 25 includes a first damper fixing portion 25a and a second damper fixing portion 25b.

The first damper fixing portion 25a and the second damper fixing portion 25b are disposed to sandwich the upper end portion of the damper V7a from the front and rear, with the first damper fixing portion 25a disposed in front of the damper V7a and the second damper fixing portion 25b disposed behind the damper V7a.

The arm support portion 26 is a pedestal that serves to support an arm base V7b.

The arm base V7b swingably supports a front end portion of a suspension arm V7c for suspending the left rear wheel V6L (wheel V6).

The arm support portion 26 is formed integrally with a first horizontal rib 41 to be described later.

The spring holding portion 27 is a pedestal that serves to support an upper end portion of a coil spring V7d to be sandwiched between the suspension arm V7c and the wheel house 12.

The positions of the damper fixing portion 25, the arm support portion 26, and the spring holding portion 27 on the concave surface portion 23 are not limited to the positions in this embodiment, and can be changed according to the configuration and size of the suspension V7.

The first inclined rib 31 (inclined rib 30) is formed in a thin plate shape, and rises toward the outer side in the vehicle width direction from the surface of the concave surface portion 23 (see FIGS. 3 to 6).

The first inclined rib 31 is disposed above a frame connection portion 11a, and extends from a lower portion of the rear side of the vehicle (i.e., lower portion of an outboard side in the front-rear direction of the vehicle) toward an upper portion of the front side of the vehicle (i.e., upper portion of an inboard side in the front-rear direction of the vehicle).

The first inclined rib 31 has a thickness dimension T2 that is set to be constant at any portion in the extending direction.

Further, the rear end portion of the first inclined rib 31 (i.e., outboard end portion of the first inclined rib 31 in the front-rear direction of the vehicle) is disposed at a position overlapping with the frame connection portion 11a of the concave surface portion 23 in the front-rear direction of the vehicle.

In other words, the rear end portion (i.e., outboard end portion in the front-rear direction of the vehicle) of the first inclined rib 31 is set at a position overlapping with the upper surface of the frame connection portion 11a when viewed from the side of the vehicle.

The second inclined rib 32 (inclined rib 30) is formed in a thin plate shape, and rises toward the outer side in the vehicle width direction from the surface of the concave surface portion 23.

The second inclined rib 32 is provided to extend from the lower portion of the outboard side toward the upper portion of the inboard side in the front-rear direction of the vehicle.

The second inclined rib 32 has a thickness dimension T2 that is set to be constant at any portion in the extending direction.

Further, the rear end portion of the second inclined rib 32 is disposed on an axis of the rear frame V3 (frame) and on the front side (i.e., inboard side in the front-rear direction of the vehicle) of the rear frame V3.

The third inclined rib 33 is formed in a thin plate shape, and rises toward the outer side in the vehicle width direction from the surface of the concave surface portion 23.

The third inclined rib 33 is provided to extend from the lower portion of the outboard side toward the upper portion of the inboard side in the front-rear direction of the vehicle.

The second inclined rib 32 has a thickness dimension T2 that is set to be constant at any portion in the extending direction.

The rear end portion of the third inclined rib 33 (i.e., outboard end portion of the third inclined rib 33 in the front-rear direction of the vehicle) is disposed at a position overlapping with the front edge portion of the arm support portion 26.

With this configuration, a collision load applied to the suspension arm V7c can be more effectively dispersed.

The third inclined rib 33 is provided such that the rear end portion thereof is positioned frontward of the rear end portion of the first inclined rib 31 and the rear end portion of the second inclined rib 32.

Further, the third inclined rib 33 is disposed such that the inclination angle thereof with respect to the horizontal plane (third inclination angle A33) is greater than the inclination angle (first inclination angle A31) of the first inclined rib 31 and the inclination angle (second inclination angle A32) of the second inclined rib 32.

The first horizontal rib 41 (horizontal rib 40) is provided to extend in the front-rear direction of the vehicle along the horizontal plane (see FIGS. 3 to 6).

As with the inclined rib 30, the first horizontal rib 41 is formed in a thin plate shape and rises toward the outer side in the vehicle width direction from the surface of the concave surface portion 23.

The first horizontal rib 41 has a thickness dimension T2 that is set to be constant at any portion in the extending direction.

The first horizontal rib 41 is positioned so as to overlap with the lower surface of the frame connection portion 11a in the upper-lower direction of the vehicle.

The rear end portion of the first horizontal rib 41 (i.e., outboard end portion of the first horizontal rib 41 in the front-rear direction of the vehicle) is disposed rearward of (on the outboard side of) the front end portion of the frame connection portion 11a (i.e., inboard end portion of the frame connection portion 11a).

In other words, the first horizontal rib 41 is formed so as to overlap with a lower surface portion of the frame connection portion 11a when viewed from the side of the vehicle.

The second horizontal rib 42 (horizontal rib 40) is provided to extend in the front-rear direction of the vehicle along the horizontal plane.

As with the inclined rib 30, the second horizontal rib 42 is formed in a thin plate shape and rises toward the outer side in the vehicle width direction from the surface of the concave surface portion 23.

The second horizontal rib 42 has a thickness dimension T2 that is set to be constant at any portion in the extending direction.

The second horizontal rib 42 is positioned so as to overlap with the upper surface of the frame connection portion 11a in the upper-lower direction of the vehicle.

The rear end portion of the second horizontal rib 42 (i.e., outboard end portion of the second horizontal rib 42 in the front-rear direction of the vehicle) is disposed rearward of (on the outboard side of) the front end portion of the frame connection portion 11a (i.e., inboard end portion of the frame connection portion 11a).

In other words, the second horizontal rib 42 is formed so as to overlap with an upper surface portion of the frame connection portion 11a when viewed from the side of the vehicle.

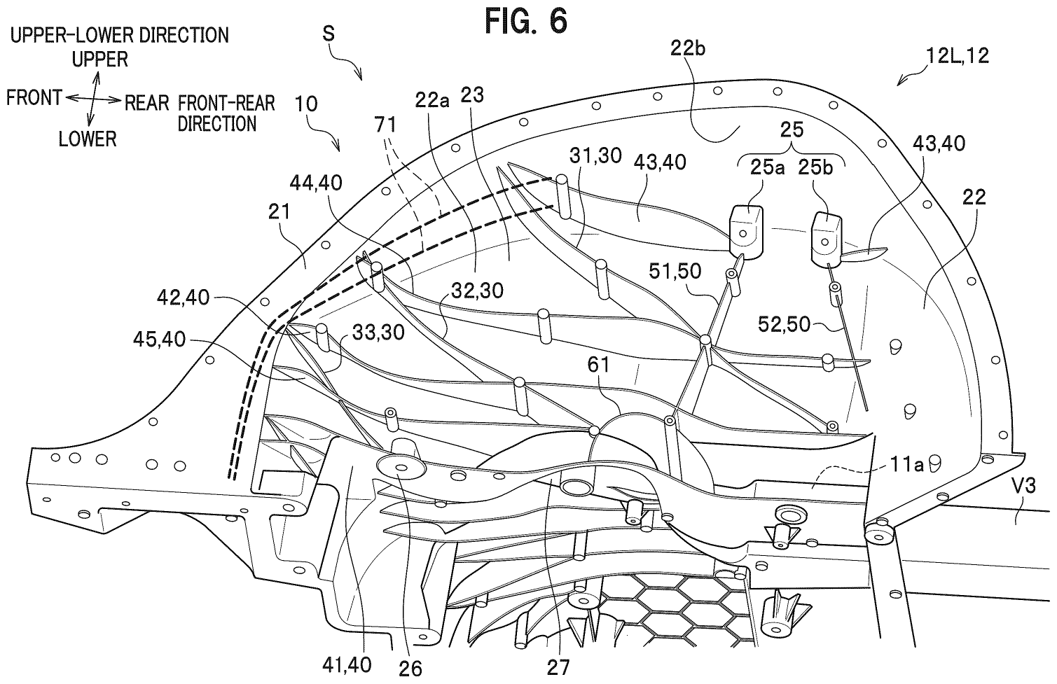

The second horizontal rib 42 protrudes outward in the vehicle width direction by a protrusion dimension T1. The second horizontal rib 42 is provided such that the protrusion dimension T1 thereof is larger at a position frontward of the front end portion of the frame connection portion 11a than at a position rearward of the front end portion of the frame connection portion 11a (see FIG. 6).

Further, the second horizontal rib 42 is disposed so as to intersect with the second inclined rib 32 and also intersect with the first damper fixing portion reinforcing rib 51.

The third horizontal rib 43 (horizontal rib 40) is provided to extend in the front-rear direction of the vehicle along the horizontal plane.

As with the inclined rib 30, the third horizontal rib 43 is formed in a thin plate shape and rises toward the outer side in the vehicle width direction from the surface of the concave surface portion 23.

The third horizontal rib 43 has a thickness dimension T2 that is set to be constant at any portion in the extending direction.

The third horizontal rib 43 is disposed at a position overlapping with the first damper fixing portion 25a (damper fixing portion) and the second damper fixing portion 25b (damper fixing portion) in the upper-lower direction of the vehicle.

The third horizontal rib 43 is interrupted between the first damper fixing portion 25a and the second damper fixing portion 25b.

This is because the third horizontal rib 43 is interrupted so as not to interfere with the damper V7a when the upper end portion of the damper V7a is supported by the first damper fixing portion 25a and the second damper fixing portion 25b.

Therefore, if the third horizontal rib 43 does not interfere with the damper V7a, the third horizontal rib 43 may be provided between the first damper fixing portion 25a and the second damper fixing portion 25b.

The upper end portion of the damper V7a is fixed to the first damper fixing portion 25a and the second damper fixing portion 25b.

Therefore, a load applied from the rear side of the second damper fixing portion 25b is transmitted to the first damper fixing portion 25a and the third horizontal rib 43 through the damper V7a.

The fourth horizontal rib 44 (horizontal rib 40) is provided to extend in the front-rear direction of the vehicle along the horizontal plane.

As with the inclined rib 30, the fourth horizontal rib 44 is formed in a thin plate shape and rises toward the outer side in the vehicle width direction from the surface of the concave surface portion 23.

The fourth horizontal rib 44 has a thickness dimension T2 that is set to be constant at any portion in the extending direction.

The fourth horizontal rib 44 is disposed at an intermediate position (approximately midway) between the third horizontal rib 43 and the second horizontal rib 42, at a position intersecting with the point (intersection point) where the first inclined rib 31 and the first damper fixing portion reinforcing rib 51 to be described later intersect with each other.

In the vehicle structure S according to this embodiment, only one fourth horizontal rib 44 is disposed as the horizontal rib 40 disposed between the third horizontal rib 43 and the second horizontal rib 42. However, the present invention is not limited to this specific configuration.

For example, if the diameter of the wheel V6 to be housed in the wheel house 12 is larger than that of this embodiment, the number of the fourth horizontal ribs 44 may be increased.

If the diameter of the wheel V6 to be housed in the wheel house 12 is smaller than that of this embodiment, the fourth horizontal rib 44 may be omitted.

The fifth horizontal rib 45 (horizontal rib 40) is provided to extend in the front-rear direction of the vehicle along the horizontal plane.

As with the inclined rib 30, the fifth horizontal rib 45 is formed in a thin plate shape and rises toward the outer side in the vehicle width direction from the surface of the concave surface portion 23.

The fifth horizontal rib 45 has a thickness dimension T2 that is set to be constant at any portion in the extending direction.

The rear end portion of the fifth horizontal rib 45 is disposed between (at an intermediate position between) the first horizontal rib 41 and the second horizontal rib 42 in the upper-lower direction of the vehicle, at a position overlapping with a spring receiving surface of the spring holding portion 27.

The fifth horizontal rib 45 is disposed at an intermediate position (approximately midway) between the lower surface portion and the upper surface portion of the frame connection portion 11a in the vehicle up-down direction, at a position frontward of the frame connection portion 11a.

In other words, the fifth horizontal rib 45 is disposed such that the rear end portion thereof (i.e., outboard end portion of the fifth horizontal rib 45 in the front-rear direction of the vehicle) is disposed frontward of (on the inboard side of) the front end portion of the frame connection portion 11a (i.e., inboard end portion of the frame connection portion 11a in the front-rear direction of the vehicle).

The first damper fixing portion reinforcing rib 51 (damper fixing portion reinforcing rib) intersects with the inclined rib 30, and is provided to extend downward from the first damper fixing portion 25a.

As with the inclined rib 30, the first damper fixing portion reinforcing rib 51 is formed in a thin plate shape and rises toward the outer side in the vehicle width direction from the surface of the concave surface portion 23 (see FIGS. 3 to 6).

In other words, the first damper fixing portion reinforcing rib 51, the first inclined rib 31, and the fourth horizontal rib 44 are arranged so as to intersect with each other at one point, when viewed from the side of the vehicle.

Further, the first damper fixing portion reinforcing rib 51 intersects with the second horizontal rib 42, and is disposed such that the lower end portion thereof is connected to the branch rib 61.

The second damper fixing portion reinforcing rib 52 (damper fixing portion reinforcing rib) is provided to extend downward from the second damper fixing portion 25b toward the frame connection portion 11a.

As with the inclined rib 30, the second damper fixing portion reinforcing rib 52 is formed in a thin plate shape and rises toward the outer side in the vehicle width direction from the surface of the concave surface portion 23 (see FIGS. 3 to 6).

In other words, the first damper fixing portion reinforcing rib 51 and the second damper fixing portion reinforcing rib 52 are formed in a substantially inverted V-shape when viewed from the side of the vehicle.

Further, the second damper fixing portion reinforcing rib 52 is disposed to intersect with the fourth horizontal rib 44.

The branch rib 61 is bent into an upwardly convex arc, is formed in a thin plate shape, and rises toward the outer side in the vehicle width direction from the surface of the concave surface portion 23.

The branch rib 61 connects the lower end portion of the first damper fixing portion reinforcing rib 51, the lower end portion of the second inclined rib 32, and the first horizontal rib 41.

The front end portion of the branch rib 61, the rear end portion of the fifth horizontal rib 45, and the rear end portion of the second inclined rib 32 are disposed so as to be connected at one point, when viewed from the side of the vehicle.

Further, the rear end portion of the branch rib 61 is disposed so as to be connected to the first horizontal rib 41.

Reinforcing ribs 71 are provided on the surface of the convex surface portion 24 of the vehicle width portion 22b that forms the wheel house 12, at a position frontward of a top portion of the wheel house 12. The reinforcing ribs 71 rise parallel to each other along the front-rear direction of the vehicle (see FIGS. 6 and 7).

The reinforcing ribs 71 extend across the front end portions of the inclined ribs 30 and the front end portions of the horizontal ribs 40, with the house body 22 positioned in between.

Although the vehicle structure S according to this embodiment has been exemplified as a structure having two reinforcing ribs 71, the present invention is not limited to this specific configuration.

For example, if the width dimension of the wheel V6 to be housed in the wheel house 12 (dimension of the vehicle width portion 22b in the vehicle width direction) is larger than that of this embodiment, the number of the reinforcing ribs 71 may be increased.

If the width dimension of the wheel V6 to be housed in the wheel house 12 is smaller than that of this embodiment, the number of the reinforcing ribs 71 may be decreased or omitted.

Advantageous effects of the vehicle structure S according to this embodiment will be described.

In the vehicle structure S of this embodiment, the first inclined rib 31 (inclined rib 30) and the second inclined rib 32 (inclined rib 30) are disposed on the concave surface portion 23, at positions above the frame connection portion 11a.

Further, the first inclined rib 31 and the second inclined rib 32 extend from the lower portion of the outboard side toward the upper portion of the inboard side in the front-rear direction of the vehicle, and rise toward the outer side in the vehicle width direction.

With this configuration, the collision load from the rear side to be input from the rear frame V3 can be transmitted to an upper front portion of the wheel house 12 via the inclined ribs 30.

Thus, the collision load from the rear side can be dispersed and absorbed in a wide range of the wheel house 12, so that the weight increase of the structural body 10 due to reinforcement can be suppressed while reducing local stress concentration.

According to this embodiment, it is possible to provide the vehicle structure S capable of reducing the weight of the vehicle while increasing the strength against a collision load. This can also contribute to improvement in energy efficiency.

In this embodiment, when viewed from the side of the vehicle, the rear end portion (i.e., outboard end portion) of the first inclined rib 31 is set at a position overlapping with the frame connection portion 11a of the concave surface portion 23 in the front-rear direction of the vehicle.

With this configuration, the collision load from the rear side can be more efficiently dispersed and transmitted to the wheel house 12.

In this embodiment, the rear end portion (outboard end portion) of the second inclined rib 32 is arranged to be positioned in front of the rear frame V3 along the extension of the axis of the rear frame V3 (i.e., on the inboard side of the concave surface portion 23 in the front-rear direction of the vehicle).

With this configuration, even at the front of the frame connection portion 11a, the collision load from the rear side can be dispersed over a wide area of the wheel house 12.

In this embodiment, the third inclined rib 33 is arranged such that the rear end portion thereof is positioned frontward of (on an inboard side in the front-rear direction of the vehicle with respect to) the rear end portion (outboard end portion) of the second inclined rib 32, extends from the lower portion of the outboard side toward the upper portion of the inboard side in the front-rear direction of the vehicle, and rises toward the outer side in the vehicle width direction.

Arranging the third inclined rib 33 further forward on the vehicle body than the first inclined rib 31 and the second inclined rib 32 makes it possible to disperse the collision load from the rear side over a wider area.

The third inclined rib 33 is configured such that the inclination angle (third inclination angle A33) thereof is greater than the inclination angle of the first inclined rib 31 (first inclination angle A31) and the inclination angle of the second inclined rib 32 (second inclination angle A32).

Setting the third inclination angle A33 greater than the first inclination angle A31 and the second inclination angle A32 makes it possible to suppress rotation of the wheel house 12 and to efficiently transmit the collision load.

The collision load transmitted from the rear frame V3 lifts the rear end of the wheel house 12 upward, and a load rotating in the counterclockwise direction in FIG. 8 is generated.

Therefore, the upward load input is larger in the front side of the wheel house 12 than in the rear side.

Therefore, setting the third inclination angle A33 greater than the first inclination angle A31 and the second inclination angle A32 make it possible to suppress rotation of the wheel house 12 and to efficiently transmit the collision load.

In this embodiment, the first damper fixing portion reinforcing rib 51 extends downward from the damper fixing portion 25 while intersecting with the first inclined rib 31.

Since the first damper fixing portion reinforcing rib 51 and the first inclined rib 31 intersect each other, the load in the upper-lower direction to be input from the damper fixing portion 25 can be dispersed to the first inclined ribs 31.

This can suppress local stress concentration.

In this embodiment, the branch rib 61 is provided to rise toward the outer side in the vehicle width direction while connecting the lower end portion of the first damper fixing portion reinforcing rib 51 and the lower end portion of the second inclined rib 32.

With this configuration, the branch rib 61 can transmit the load in the upper-lower direction to be input from the first damper fixing portion 25a to the second inclined rib 32, so that local stress concentration can be suppressed.

In this embodiment, the second damper fixing portion reinforcing rib 52 extends downward from the second damper fixing portion 25b toward the frame connection portion 11a, and rises toward the outer side in the vehicle width direction.

With this configuration of providing the second damper fixing portion reinforcing rib 52, the second damper fixing portion 25b and the vicinity of the upper side of the frame connection portion 11a are connected to each other.

Accordingly, the second damper fixing portion 25b can be firmly supported without the need to separately provide a reinforcing member.

Further, with this configuration, the collision load from the rear side to be input from the rear frame V3 can be dispersed over a wider range.

In this embodiment, the first damper fixing portion reinforcing rib 51 and the second damper fixing portion reinforcing rib 52 are disposed such that the distance therebetween gradually increases from top toward bottom to form a substantially inverted V-shape.

With this configuration, the load in the upper-lower direction to be transmitted from the damper V7a can be more firmly received and supported without the need to separately provide a reinforcing member.

Further, the collision load from the rear side to be input from the rear frame V3 to the vehicle body V1 can be dispersed over a wider range.

Further, in this embodiment, the reinforcing rib 71 is disposed on the convex surface portion 24 at a position intersecting with the front end portions of the first to third inclined ribs 33.

With this configuration, the collision load from the rear side of the vehicle to be transmitted from each of the inclined ribs can be firmly received, and the load can be dispersed over a wider range of the wheel house.

The vehicle structure S of this embodiment has been described with reference to the vehicle body rear structure that supports the rear wheels. However, the present invention is not limited to this specific configuration.

For example, the present invention can be applied to a vehicle body front structure that supports front wheels, and the same advantageous effects as those of this embodiment can be obtained.

In this case, the inboard side in the front-rear direction of the vehicle indicates the rear side of the vehicle, and the outboard side in the front-rear direction of the vehicle indicates the front side of the vehicle.

What is claimed is:

1. A vehicle structure comprising a structural body, in which a pair of wheel houses disposed apart from each other in a right-left direction, and a floor panel connecting the pair of wheel houses are integrally formed by die casting, wherein
the floor panel includes a frame connection portion, to which an inboard end portion of a frame extending along a front-rear direction of a vehicle is connected,
each of the wheel houses is shaped like a shell and includes:
a concave surface portion that faces outward in a vehicle width direction and is formed of a concave curved surface curved in a substantially spherical shape, and
a convex surface portion that is formed on a back side of the concave surface portion, protrudes inward in the vehicle width direction, and is formed of a convex curved surface curved in a substantially spherical shape,
the concave surface portion is disposed so as to face outward in the vehicle width direction, and a part of a wheel is housed in the concave surface portion, and
the concave surface portion has an inclined rib that is disposed above the frame connection portion, that extends from a lower portion of an outboard side toward an upper portion of an inboard side in the front-rear direction of the vehicle, and that rises toward an outer side in the vehicle width direction.

2. The vehicle structure according to claim 1, wherein the inclined rib comprises a first inclined rib having an outboard end portion, and
the outboard end portion of the first inclined rib is disposed at a position overlapping with the frame connection portion in the front-rear direction of the concave surface portion.

3. The vehicle structure according to claim 1, wherein the inclined rib comprises a second inclined rib having an outboard end portion, and
the outboard end portion of the second inclined rib is disposed on an extension line of an axis of the frame and on an inboard side of the concave surface portion in the front-rear direction of the vehicle.

4. The vehicle structure according to claim 1, wherein the concave surface portion has a third inclined rib that is disposed on an inboard side in the front-rear direction of the vehicle with respect to an outboard end portion of the inclined rib in the front-rear direction of the vehicle, that extends from the lower portion of the outboard side toward the upper portion of the inboard side in the front-rear direction of the vehicle, and that rises toward the outer side in the vehicle width direction, and
the third inclined rib is disposed such that an inclination angle thereof is larger than that of the inclined rib.

5. The vehicle structure according to claim 1, wherein the concave surface portion includes:
a damper fixing portion that supports a damper at a top portion of the concave surface portion in an upper-lower direction of the vehicle, and
a first damper fixing portion reinforcing rib that intersects with the inclined rib, extends downward from the damper fixing portion, and rises toward the outer side in the vehicle width direction.

6. The vehicle structure according to claim 5, wherein the concave surface portion includes a branch rib that connects a lower end portion of the first damper fixing portion reinforcing rib and a lower end portion of the inclined rib and that rises toward the outer side in the vehicle width direction.

7. The vehicle structure according to claim 1, wherein the concave surface portion includes:
a damper fixing portion at a top portion of the concave surface portion in an upper-lower direction of the vehicle, and
a second damper fixing portion reinforcing rib that extends downward from the damper fixing portion toward the frame connection portion and rises toward the outer side in the vehicle width direction.

8. The vehicle structure according to claim 5, wherein the concave surface portion includes:
a second damper fixing portion reinforcing rib that extends downward from the damper fixing portion toward the frame connection portion and rises toward the outer side in the vehicle width direction, and
the first damper fixing portion reinforcing rib and the second damper fixing portion reinforcing rib are disposed such that a distance therebetween gradually increases from top toward bottom.

9. The vehicle structure according to claim 1, wherein the convex surface portion includes a reinforcing rib that rises along the front-rear direction of the vehicle, and
the reinforcing rib is disposed at a position intersecting with an inboard end portion of the inclined rib in the front-rear direction of the vehicle.
